(19) United States
(12) Patent Application Publication
(10) Pub. No.: US 2015/0381041 A1
(43) Pub. Date: Dec. 31, 2015

(54) LOW-LIGHT SOLAR BOOST CONVERTER AND CONTROL METHOD THEREFOR

(71) Applicants: YUN-SHAN CHANG, SAN JOSE, CA (US); DA-WEI LIN, NEW TAIPEI CITY (TW)

(72) Inventor: YUN-SHAN CHANG, SAN JOSE, CA (US)

(21) Appl. No.: 14/316,983

(22) Filed: Jun. 27, 2014

(51) Int. Cl. H02M 3/158

(52) U.S. Cl. CPC H02M 3/158

(57) ABSTRACT

The present disclosure provides a low-light solar boost converter and a control method therefore. The control method comprises the boost converter starting to operate in a PWM mode; determining whether the voltage of the input terminal is larger than a reference input voltage, the boost converter operating in the PWM mode when the voltage of the input terminal is larger than the reference input voltage, otherwise the boost converter operating in a burst mode, wherein a burst time period of the burst mode increases when the voltage of the input terminal decreases; during the burst mode determining whether the voltage of the output terminal is less than a first preset output voltage, the boost converter operating in the PWM mode when the voltage of the output terminal is less than the first preset output voltage, otherwise the boost converter operating in the burst mode.

### BACKGROUND OF THE INVENTION

1. Field of the Invention

The instant disclosure relates to a boost converter; in particular, to a low-light solar boost converter and a control method therefor.

2. Description of Related Art

Solar energy is a promising clean energy source. Although many of designs and manufacture technologies are invented from five to six decades ago the efficiency and cost structure are still the many core issues of this clean energy harvesting. Due to the outdoor unpredictable solar irradiation and low indoor lighting illumination the photovoltaic energy harvesting is not well prevailing around our daily life. Because of the environmental pollution and energy source depletion the more improvements on efficiency and design are invented recently. The silicon based solar panel with crystal enhancement and coating structure are pushing into the market yearly by yearly. But the photovoltaic conversion is still one of the bottle necks in this clean energy harvesting.

There are many inventions on the energy harvesting for different fabricated solar panels. The silicon based is most possible energy source for commercialization as compared to III-V, II-VI compounds, organic thin film, etc. due to the durability and cost structure. Several harvesting skills listed as follows still have some drawbacks. Regulated output boost: nothing to do with supply source fluctuation and cannot be adaptive to environment variation. Regulated output Burst mode boost: only dependent on the loading condition and the burst period is only set on one mode condition. Switch-cap pumping boost: high EMI and low converted efficiency and restricted by conversion ratio to the final voltage. Fixed frequency and burst period switch boost: cannot adjust the loading and energy conversion balance.

### SUMMARY OF THE INVENTION

The object of the instant disclosure is to provide a low-light solar boost converter and a control method therefor which utilize regulation and switching control for the input voltage in order to reduce the energy conversion loss during low-light irradiation condition.

In order to achieve the aforementioned objects, according to an embodiment of the instant disclosure, a low-light solar boost converter is offered. The low-light solar boost converter has an input terminal and an output terminal. The input terminal is coupled to a solar energy receiving unit. The output terminal is coupled to a load. The low-light solar boost converter comprises a boost converter, a pulse width modulation controller and a switching controller. The boost converter is coupled to the input terminal and the output terminal. The pulse width modulation controller is coupled to the boost converter and provides a plurality of pulses to the boost converter for adjusting the voltage of the output terminal. The pulse width modulation controller operates in a PWM (pulse width modulation) mode when the voltage of the input terminal is larger than a reference input voltage. The pulse width modulation controller operates in a burst mode when the voltage of the input terminal is not larger than the reference input voltage. A burst time period of the burst mode increases when the voltage of the input terminal decreases. The switching controller is coupled to the pulse width modulation controller and determines whether the voltage of the output terminal is less than a first preset output voltage. The switching controller controls the pulse width modulation controller to operate in the PWM mode when the voltage of the output terminal is less than the first preset output voltage. The switching controller controls the pulse width modulation controller to operate in the burst mode when the voltage of the output terminal is not less than the first preset output voltage.

In order to achieve the aforementioned objects, according to an embodiment of the instant disclosure, a control method for a low-light solar boost converter is offered. The low-light solar boost converter has an input terminal and an output terminal. The control method comprises following steps. Firstly, the boost converter starting to operate in a PWM mode. Then, determining whether the voltage of the input terminal is larger than a reference input voltage. And, controlling the low-light solar boost converter to operate in a PWM mode when the voltage of the input terminal is larger than a reference input voltage; otherwise, controlling the low-light solar boost converter to operate in a burst mode when the voltage of the input terminal is not larger than the reference input voltage, wherein a burst time period of the burst mode increases when the voltage of the input terminal decreases. Then, determining whether the voltage of the output terminal is less than a first preset output voltage when operating in the burst mode. And, controlling the low-light solar boost converter to operate in the PWM mode when the voltage of the output terminal is less than a first preset output voltage; otherwise, controlling the low-light solar boost converter to operate in the burst mode when the voltage of the output terminal is not less than the first preset output voltage.

In summary, the provided low-light solar boost converter and the control method therefor could acquire the loading status according to the voltage of the output terminal and control the boost converter to operate in the burst mode during light load, wherein the burst time period of the burst mode increases when the voltage of the input terminal decreases, that is the lower irradiation leads to extension of the burst time period. Further, determination of whether the boost converter leave the burst mode and enter the PWM mode would be made according to the loading status also.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a circuit diagram of an adaptive solar energy harvesting device according to an embodiment of the instant disclosure;

FIG. 2 shows a circuit diagram of a low-light solar boost converter according to an embodiment of the instant disclosure;

FIG. 3 shows a flow chart of a control method for a low-light solar boost converter according to an embodiment of the instant disclosure;

FIG. 4 shows a flow chart of a control method for a low-light solar boost converter according to another embodiment of the instant disclosure;

FIG. 5 shows a signal waveform of a low-light solar boost converter according to an embodiment of the instant disclosure;

FIG. 6 shows a signal waveform of a low-light solar boost converter according to another embodiment of the instant disclosure;

FIG. 7 shows a signal waveform of a low-light solar boost converter according to another embodiment of the instant disclosure;

FIG. 8 shows a signal waveform of a low-light solar boost converter according to another embodiment of the instant disclosure; and

FIG. 9 shows a signal waveform of a low-light solar boost converter according to another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

[An Embodiment of a Low-Light Solar Boost Converter and a Control Method Therefor]

This embodiment provides a further improvement on the low irradiation condition photo-voltaic energy harvesting. A regulating on solar energy harvesting output voltage to monitor the solar panel harvesting capability and to adjust the conversion switching rate is an effective method to save more on energy conversion loss during low irradiation harvesting.

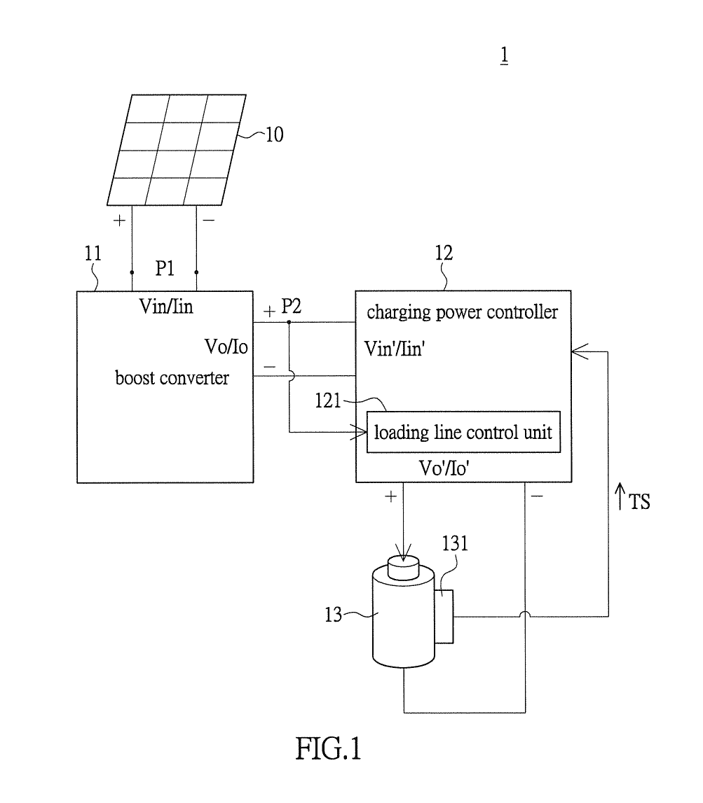

Please refer to FIG. 1 showing a circuit diagram of an adaptive solar energy harvesting device according to an embodiment of the instant disclosure. The adaptive solar energy harvesting device 1 comprises a solar energy receiving unit 10, a boost converter 11 and a charging power controller 12. The solar energy receiving unit 10 usually is a solar panel having a plurality of solar cells. The adaptive solar energy harvesting device 1 transmits the electricity of the solar energy receiving unit 10 to at least an electricity storage unit 13.

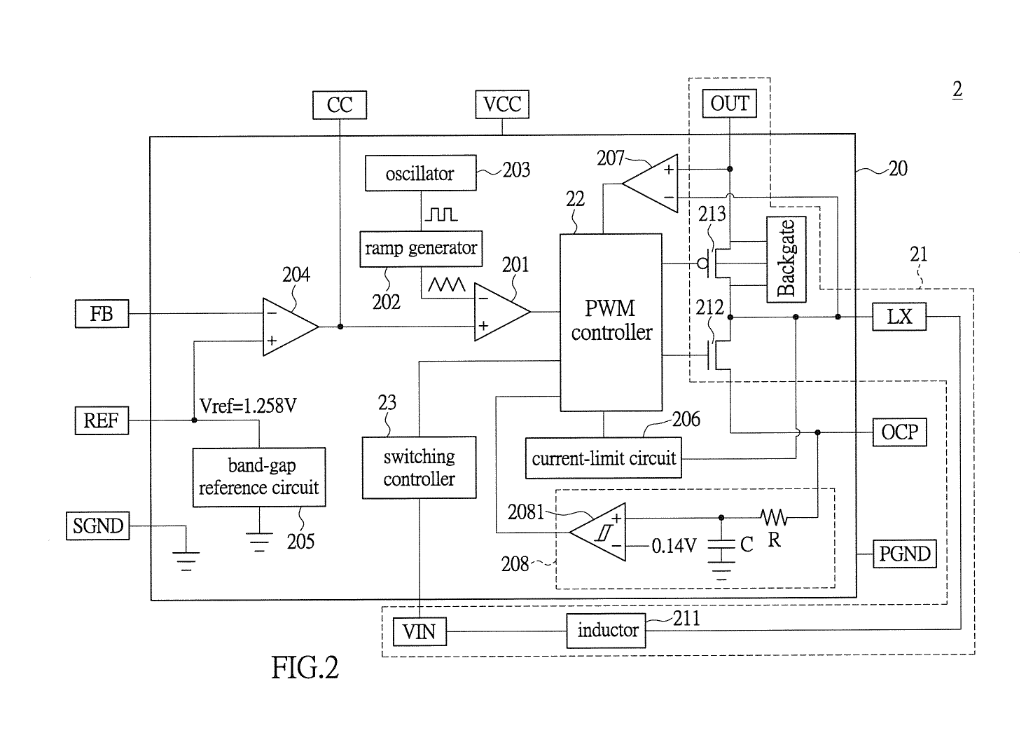

The boost converter 11 has an input terminal P1 and an output terminal P2. The input terminal P1 is coupled to the solar energy receiving unit 10. The boost converter 11 receives the electricity from the solar energy receiving unit 10 through the input terminal P1. The solar energy receiving unit 10 provides input voltage Vin and input current Tin to the boost converter 11. The charging power controller 12 is coupled to the output terminal P2 of the boost converter 11. The charging power controller 12 senses a supply voltage Vo of the output terminal P2 of the boost converter 11 (wherein the input terminal Vin′ of the charging power controller 12 is also shown in FIG. 2), and generates a charging voltage Vo′ and a charging current Io′ to charge at least an electricity storage unit 13. The charging power controller 12 adjusts the charging current Io′ according the feed-forward control related to the supply voltage Vo at the output terminal P2 of the boost converter 11. The mentioned feed-forward control may self-adjust the energy harvest of the solar panel and converts the energy to be stored in the chargeable energy storage unit (which is the electricity storage unit 13). Thus, no matter how much the harvested energy is, less or more energy could be stored as long as the harvested energy is larger than the energy consumption of the boost converter 11 and the charging power controller 12.

This embodiment utilizes the charging power controller 12 which has the capability to adaptive adjust the ability of harvesting energy according to the loading. For different intensity of the incident light, each solar cell has itself energy harvesting ability for outputting electricity. If the harvest load is not matched to output generation of solar cells then the output voltage of solar cells would collapse and drop to near ground or lower voltage values under heavy loading drain. To overcome such a problem it is proposed to have the loading forward adjustment to the output (post) stage of the photo-voltaic conversion the energy storage. Every boost clock cycle from the harvested photo-voltaic into voltaic value the post stage which stores the harvested solar energy into electrochemical battery energy is automatically adjusted to accommodate the photo-voltaic output capability from delivered capability of former stage.

The electricity storage unit 13 usually is a secondary battery, such as the lithium nickel battery or the lithium-ion battery, but the instant disclosure is not so restricted. The electricity storage unit 13 is coupled to the charging power controller 12. The electricity storage unit 13 receives the charging voltage Vo′ and the charging current Io′ to be charged. The electricity storage unit 13 may comprise a temperature sensory device 131. The temperature sensory device 131 senses the temperature of the electricity storage unit 13 and provides a temperature sensing signal TS to the charging power controller 12. The temperature sensory device 131 may provide the temperature sensing signal TS to indicate the charging power controller 12 to stop charging the electricity storage unit 13. Accordingly, over temperature of the electricity storage unit 13 could be avoided for safety. The charging power controller 12 may adjust the loading line of charging the electricity storage unit 13 according to the supply voltage Vo when the adaptive solar energy harvesting device 1 charges the electricity storage unit 13.

Furthermore, during low-light irradiation condition, the energy conversion loss of the boost converter 11 affects the available output power of the boost converter 11. This embodiment of the present disclosure provides further design on the control method of the boost converter 11 in order to reduce energy conversion loss during low-light irradiation condition.

Please refer to FIG. 1 in conjunction with FIG. 2, FIG. 2 shows a circuit diagram of a low-light solar boost converter according to an embodiment of the instant disclosure. The low-light solar boost converter 2 has an input terminal VIN (which is identical to the input terminal P1 of the boost converter 11 having the voltage Vin) and an output terminal OUT (which is identical to the output terminal P2 of the boost converter 11 having the voltage Vo). The input terminal VIN is coupled to the solar energy receiving unit 10 shown in FIG. 1. The output terminal OUT is coupled to a load (for example the charging power controller 12, alternatively the output terminal OUT may be directly coupled to the electricity storage unit 13). The low-light solar boost converter 2 can be implemented by a packaged integrated circuit 20 cooperating with an inductor 211. In view of the circuit architecture, the low-light solar boost converter 2 comprises a boost converter 21, a pulse width modulation (PWM) controller 22, a switching controller 23, a PWM comparator 201, a ramp generator 202, an oscillator 203, an error amplifier 204, a band-gap reference circuit 205, a current-limit circuit 206, a zero-crossing rate (ZCR) comparator 207 and an over current protector (OCP) 208.

The boost converter 21 is a DC boost converter. The boost converter 21 comprises the inductor 211 and at least a transistor 212 (or 213) coupled to the inductor 211. In FIG. 2, the transistor 213 is a P-type transistor having a backgate, and the transistor 212 is a N-type transistor. The boost converter 21 is coupled to the input terminal VIN and the output terminal OUT. A terminal of the inductor 211 is coupled to the input terminal VIN, and another terminal (terminal LX) of the inductor 211 is coupled to at least one transistor (212 or 213), the mentioned at least one transistor (which is the transistor 213 in FIG. 2) is for being coupled to the output terminal OUT. The boost converter 21 shown in FIG. 2 is for ease of description, but not for restricting the scope of the present invention. An artisan of ordinary skill in the art may change the connection relationship between the inductor 211 and the transistor arbitrarily as needed, or change the number of the transistors coupled to the inductor in practical applications. In short, the boost converter 21 may have at least one transistor coupled to the output terminal OUT, and the pulses generated by the pulse width modulation controller 22 are for controlling the switching of the mentioned transistor.

The pulse width modulation controller 22 is coupled to the boost converter 21 and provides a plurality of pulses to the boost converter 21 for adjusting the voltage of the output terminal OUT. In this embodiment, the pulses generated by the pulse width modulation controller 22 are for controlling the switching of the transistors 212, 213. The pulse width modulation controller 22 operates in a PWM mode when the voltage of the input terminal VIN is larger than a reference input voltage, which means the low-light solar boost converter 2 is controlled to operate in the PWM mode. The pulse width modulation controller 22 operates in a burst mode when the voltage of the input terminal VIN is not larger than the reference input voltage. A burst time period EN_OSC is a function of the voltage of the input terminal VIN (that is EX_OSC=f(Vin)), and the burst time period EN_OSC of the burst mode increases when the voltage of the input terminal VIN decreases.

The switching controller 23 is coupled to the pulse width modulation controller 22 and determines whether the voltage of the output terminal OUT is less than a first preset output voltage V1. The switching controller 23 controls the pulse width modulation controller 22 to operate in the PWM mode when the voltage of the output terminal OUT is less than the first preset output voltage V1. The switching controller 23 controls the pulse width modulation controller 22 to operate in the burst mode when the voltage of the output terminal OUT is not less than the first preset output voltage V1.

The pulse width of the pulse width modulation controller 22 is controlled by the PWM comparator 201. The PWM comparator 201 utilizes the triangular wave generated by the ramp generator 202 (in which the ramp generator 202 generates triangular wave according to the oscillator 203) as a reference signal, and the PWM comparator 201 compares the triangular wave with the output voltage of the error amplifier 204 to provide a signal controlling the pulse width of the pulse width modulation controller 22. Two input terminals of the error amplifier 204 are respectively coupled to the feedback terminal FB and the reference terminal REF. The error amplifier 204 compares the voltage of the feedback terminal FB (which is the feedback signal according to the voltage or current of the output terminal OUT) and the voltage of the reference terminal REF, wherein the voltage of the reference terminal REF is related to the voltage generated by the band-gap reference circuit 205, wherein the voltage Vref of the reference terminal REF, Vref=1.258V, is just an example which is not for restricting the scope of the present invention. The current-limit circuit 206, the zero-crossing rate (ZCR) comparator 207 and the over current protector (OCP) 208 are coupled to the pulse width modulation controller 22 for protecting the circuit. The over current protector 208 may be implemented by the comparator 2081, the resistor R and the capacitor C for example. Additionally, the other terminals SGND [symbol] POND [symbol] OCP [symbol] VCC [symbol] CC of the integrated circuit 20 and the related circuit topology is exemplary provided, the present disclosure is not so restricted. The integrated circuit 20 may added with other additional features, such as the Smith-Trigger and the Power Good signal which are omitted therein.

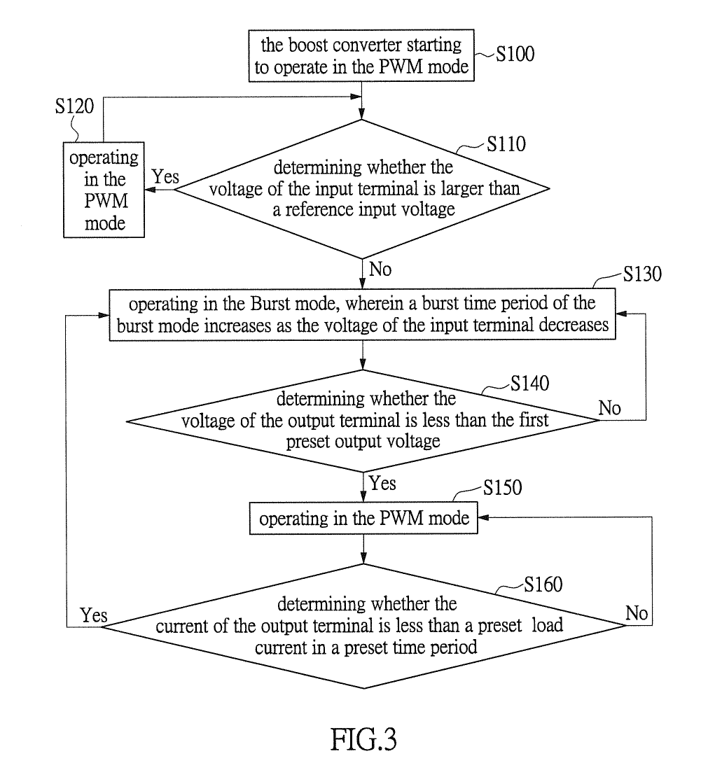

Please refer to FIG. 2 in conjunction with FIG. 3, FIG. 3 shows a flow chart of a control method for a low-light solar boost converter according to an embodiment of the instant disclosure. Firstly, in step S100, the low-light solar boost converter 2 starting to operate in a PWM mode. Then, in step S110, determining whether the voltage of the input terminal VIN is larger than a reference input voltage (VIN_REF which is not shown in the figure). The mentioned reference input voltage is the basis of determining whether the boost converter needs to operate in the PWM mode. When the input voltage is too low (not larger than the reference input voltage) it means the irradiation of sun light may be quite low which could not provide a large amount of energy, therefore the boost converter needs to save power consumption. And, when the voltage of the input terminal VIN is larger than the reference input voltage (VIN_REF), then step S120 is executed. In step S120, controlling the low-light solar boost converter 2 to operate in the PWM mode, and then executing S110 again after step S120. Otherwise, when the voltage of the input terminal VIN is not larger than the reference input voltage (VIN_REF), then step S130 is executed. In step S130, controlling the low-light solar boost converter 2 to operate in the burst mode, wherein the burst time period EN_OSC of the burst mode increases when the voltage of the input terminal VIN decreases.

Then, during the burst mode, executing step S140, determining whether the voltage of the output terminal OUT is less than a first preset output voltage V1. And, when the voltage of the output terminal OUT is less than the first preset output voltage V1, executing step S150, controlling the low-light solar boost converter 2 to operate in the PWM mode; otherwise, when the voltage of the output terminal OUT is not less than the first preset output voltage V1, executing step S130 again for controlling the low-light solar boost converter 2 to operate in the burst mode again. After step S150, executing step S160, detecting whether the current I_load of the output terminal OUT is less than a preset load current in a preset time period ΔT. When the current I_load of the output terminal OUT is less than the preset load current, executing step S130 again, controlling the low-light solar boost converter 2 to operate in the burst mode. Otherwise, when the current I_load of the output terminal OUT is not less than the preset load current, executing step S150 again, controlling the low-light solar boost converter 2 to operate in the PWM mode. The purpose of step S160 is only for detecting the current of the output terminal OUT during the preset time period ΔT, in order to avoid affecting the stability of the whole system due to the noises or current fluctuations. It is worth mentioning that, in other embodiments, the step S160 may be replaced by other decision action and steps for determining whether to maintain the operation in the PWM mode or change the operation to the burst mode, for example utilizing the step S140 (or a step similar to step S140) to determining whether to leave the PWM mode and enter the burst mode.

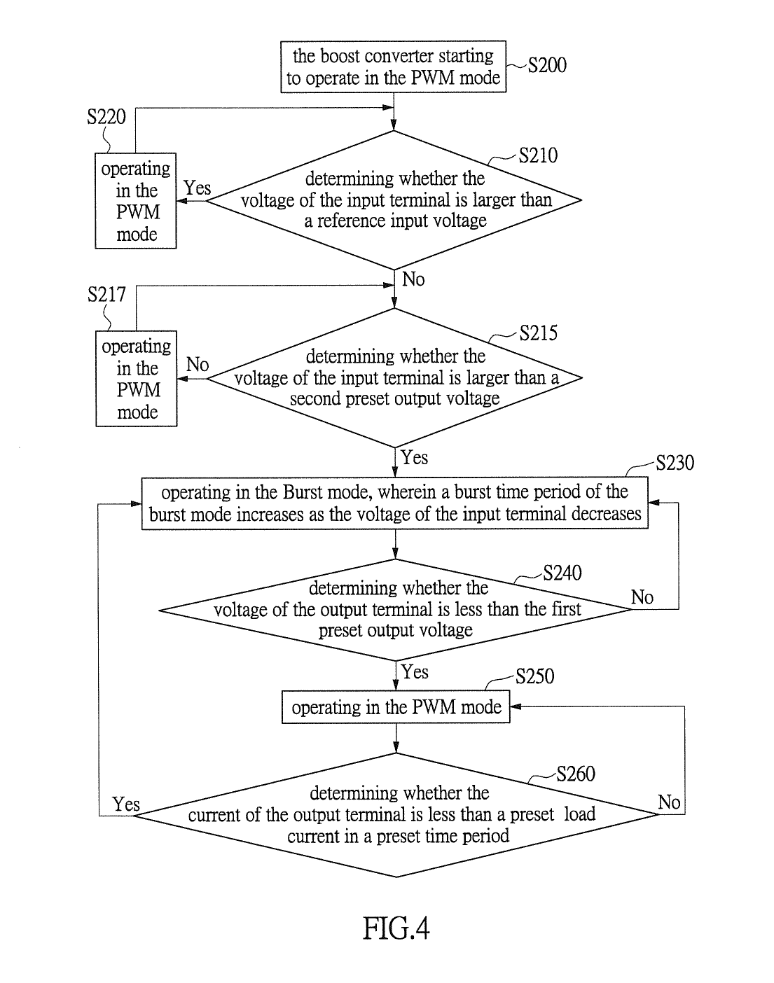

Please refer to FIG. 3 in conjunction with FIG. 4, FIG. 4 shows a flow chart of a control method for a low-light solar boost converter according to another embodiment of the instant disclosure. The flow chart of FIG. 4 is significantly identical to the flow chart shown in FIG. 3 except for the added steps S215 and S217. The steps S200, S210, S220, S230, S240, S250 and S260 in FIG. 4 are respectively identical to the steps S100, S110, S120, S130, S140, S150 and S160, thus the redundant information is not repeated. The added steps of FIG. 4 are described in the follows. After the step (S210) of determining whether the voltage of the input terminal VIN is larger than the reference input voltage (VIN_REF) and before the step (S230) of operating in the burst mode, the control method further comprises steps S215 and S217. In step S215, determining whether the voltage of the output terminal OUT is larger than a second preset output voltage V2. When the voltage of the output terminal OUT is larger than the second preset output voltage V2 controlling the low-light solar boost converter 2 to operate in the burst mode, that is executing step S230. When the voltage of the output terminal OUT is not larger than the second preset output voltage V2 controlling the low-light solar boost converter 2 to operate in the PWM mode, that is executing step S217. After step S217, executing step S215 again. The steps S215 and S217 are for detecting whether the loading of the output terminal OUT is heavy load or light load before entering the burst mode. Meanwhile, the effects of the step S215 and the step S240 are similar, which are for detecting the loading condition, wherein the second preset output voltage V2 and the first output voltage V1 may be the same or not the same, and the instant disclosure is not restricted thereto.

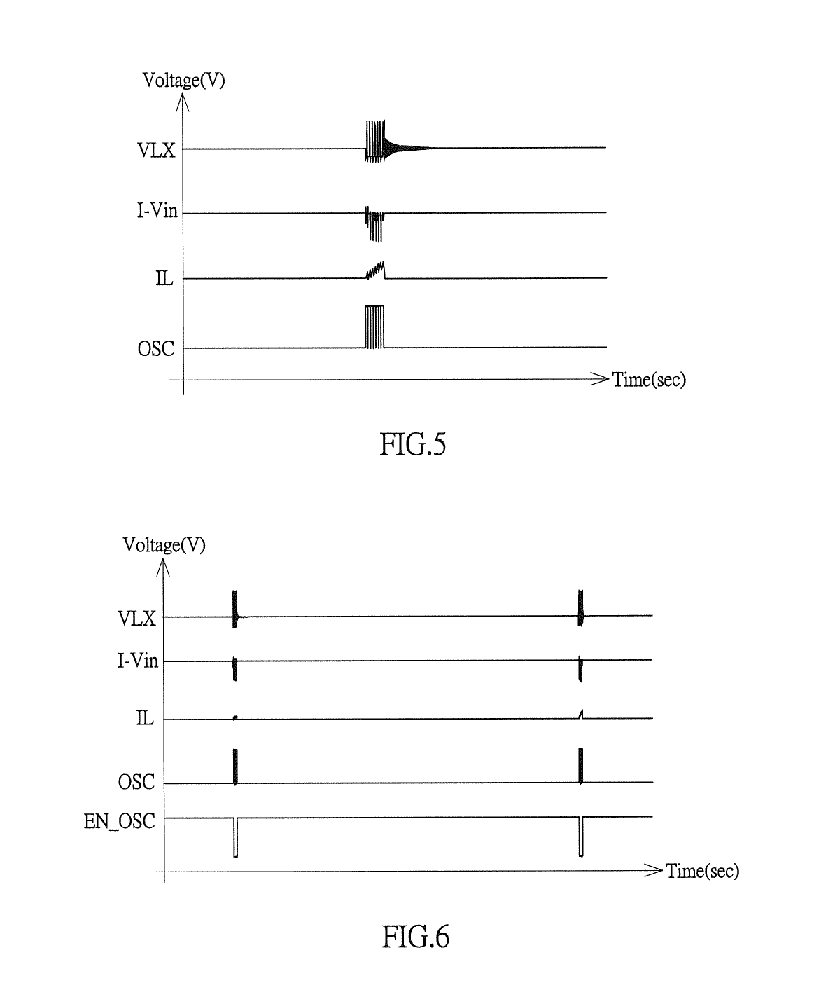

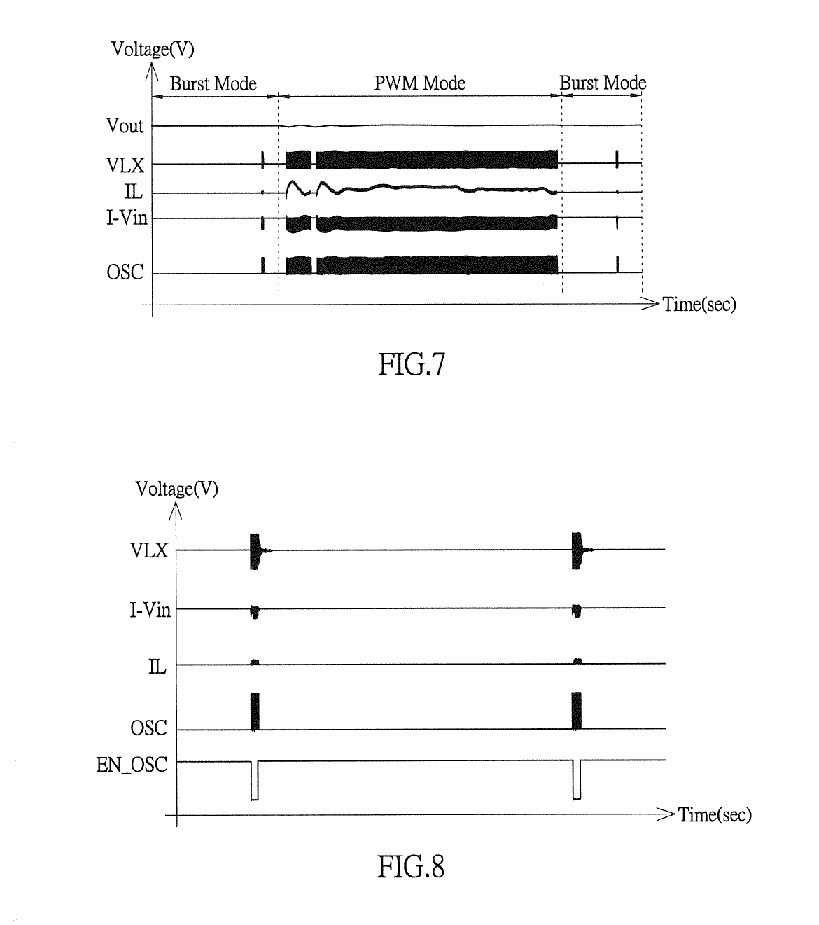

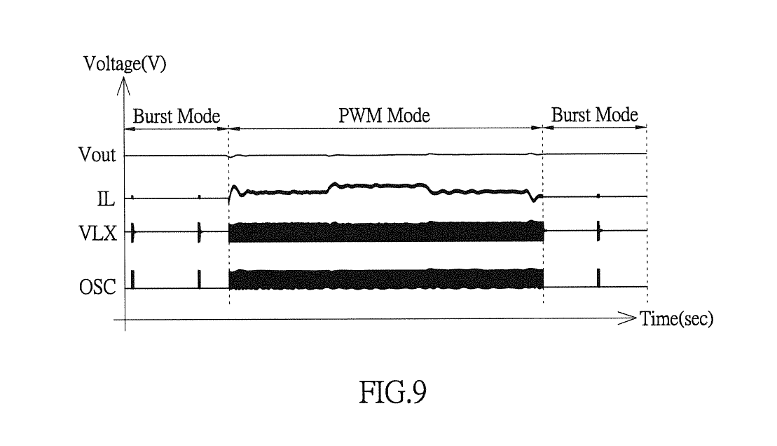

Please refer to FIG. 2 in conjunction with FIG. 5 to FIG. 9, FIG. 5 shows the voltage VLX of the terminal LX, the current I-Vin of the input terminal VIN, the current IL of the inductor 211 and the pulses OSC generated by the pulse width modulation controller 22 when the voltage (Vin) of the input terminal VIN is 1.2V. FIG. 6 further shows the burst time period EN_OSC is 979 us when the voltage (Vin) of the input terminal VIN is 1.2V. FIG. 7 shows the signal waveforms when the circuit operation changes from the burst mode to the PWM mode and then changes to the burst mode again, wherein the load current is 25 mA in the PWM mode, meanwhile the voltage (Vin) of the input terminal VIN is 1.1V. FIG. 8 shows the burst time period EN_OSC is reduced to 399 us when the voltage (Vin) of the input terminal VIN is 3V. FIG. 9 shows the signal waveforms when the circuit operation changes from the burst mode to the PWM mode and then changes to the burst mode again, wherein the load current is 200 mA in the PWM mode, meanwhile the voltage (Vin) of the input terminal VIN is 3V. According to FIG. 9, it can be obviously seen that the separation (which is the burst time period EN_OSC) between each pulse of the signal OSC is shorter than the separation between the pulses shown in FIG. 7.

According to above descriptions, the provided low-light solar boost converter and the control method therefor could acquire the loading status according to the voltage of the output terminal and control the boost converter to operate in the burst mode during light load, wherein the burst time period of the burst mode increases when the voltage of the input terminal decreases, that is the lower irradiation leads to extension of the burst time period. Further, determination of whether the boost converter leave the burst mode and enter the PWM mode would be made according to the loading status also. Accordingly, the energy conversion loss could be reduced during low-light irradiation condition, and the energy conversion efficiency could be improved.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A low-light solar boost converter having an input terminal and an output terminal, the input terminal coupled to a solar energy receiving unit, the output terminal coupled to a load, the low-light solar boost converter comprising:
a boost converter, coupled to the input terminal and the output terminal;
a pulse width modulation controller, coupled to the boost converter, providing a plurality of pulses to the boost converter for adjusting the voltage of the output terminal, wherein the pulse width modulation controller operates in a PWM (pulse width modulation) mode when the voltage of the input terminal is larger than a reference input voltage, the pulse width modulation controller operates in a burst mode when the voltage of the input terminal is not larger than the reference input voltage, a burst time period of the burst mode increases when the voltage of the input terminal decreases; and
a switching controller, coupled to the pulse width modulation controller, determining whether the voltage of the output terminal is less than a first preset output voltage, wherein the switching controller controls the pulse width modulation controller to operate in the PWM mode when the voltage of the output terminal is less than the first preset output voltage, the switching controller controls the pulse width modulation controller to operate in the burst mode when the voltage of the output terminal is not less than the first preset output voltage.

2. The low-light solar boost converter according to claim 1, wherein the switching controller determines whether the voltage of the output terminal is larger than a second preset output voltage, the switching controller controls the pulse width modulation controller to operate in the burst mode when the voltage of the output terminal is larger than the second preset output voltage, the switching controller controls the pulse width modulation controller to operate in the PWM mode when the voltage of the output terminal is not larger than the second preset output voltage.

3. The low-light solar boost converter according to claim 1, wherein the boost converter is a DC booster converter.

4. The low-light solar boost converter according to claim 1, wherein the boost converter has at least a transistor, the transistor is coupled to the output terminal, the pulses generated by the pulse width modulation controller is for controlling the switching of the transistor.

5. A control method for a low-light solar boost converter, the low-light solar boost converter having an input terminal and an output terminal, the control method comprising:
the boost converter starting to operate in a PWM mode;
determining whether the voltage of the input terminal is larger than a reference input voltage;
controlling the low-light solar boost converter to operate in a PWM mode when the voltage of the input terminal is larger than the reference input voltage;
controlling the low-light solar boost converter to operate in a burst mode when the voltage of the input terminal is not larger than the reference input voltage, wherein a burst time period of the burst mode increases when the voltage of the input terminal decreases;
determining whether the voltage of the output terminal is less than a first preset output voltage when operating in the burst mode;
controlling the low-light solar boost converter to operate in the PWM mode when the voltage of the output terminal is less than a first preset output voltage; and
controlling the low-light solar boost converter to operate in the burst mode when the voltage of the output terminal is not less than the first preset output voltage.

6. The control method for the low-light solar boost converter according to claim 5, wherein after the step of determining whether the voltage of the input terminal is larger than the reference input voltage and before the step of operating in the burst mode, the control method further comprises:
determining whether the voltage of the output terminal is larger than a second preset output voltage;
controlling the low-light solar boost converter to operate in the burst mode when the voltage of the output terminal is larger than the second preset output voltage; and
controlling the low-light solar boost converter to operate in the PWM mode when the voltage of the output terminal is not larger than the second preset output voltage.

7. The control method for the low-light solar boost converter according to claim 5, wherein after the step of controlling the low-light solar boost converter to operate in the PWM mode when the voltage of the output terminal is less than a first preset output voltage, the control method further comprises:
detecting whether the current of the output terminal is less than a preset load current in a preset time period;
controlling the low-light solar boost converter to operate in the burst mode when the current of the output terminal is less than the preset load current; and
controlling the low-light solar boost converter to operate in the PWM mode when the current of the output terminal is not less than the preset load current.

8. The control method for the low-light solar boost converter according to claim 5, wherein the low-light solar boost converter comprises a boost converter, a pulse width modulation controller and a switching controller, the switching controller is for controlling the pulse width modulation controller to generate a plurality of pulses, the pulses is for controlling the boost converter to adjust the voltage of the output terminal.

9. The control method for the low-light solar boost converter according to claim 8, wherein the boost converter is a DC boost converter.

10. The control method for the low-light solar boost converter according to claim 8, wherein the boost converter has at least a transistor, the transistor is coupled to the output terminal, the pulses generated by the pulse width modulation controller is for controlling the switching of the transistor.
